(19) United States
(12) Patent Application Publication
(10) Pub. No.: US 2023/0412238 A1
(43) Pub. Date: Dec. 21, 2023

(54) ENHANCING UPLINK TRANSMISSION WITH MULTIPLE BEAMS

(71) Applicant: Panasonic Intellectual Property Corporation of America, Torrance, CA (US)

(72) Inventors: Xuan Tuong TRAN, Singapore (SG); Tetsuya YAMAMOTO, Kanagawa (JP); Yoshihiko OGAWA, Kanagawa (JP)

(21) Appl. No.: 18/249,700

(22) PCT Filed: Jul. 21, 2021
(86) PCT No.: PCT/SG2021/050427

§ 371 Date: Apr. 19, 2023

(30) Foreign Application Priority Data
Oct. 23, 2020 (SG) 10202010554V
Dec. 24, 2020 (SG) 10202013045T

(51) Int. Cl. H04B 7/06; H04W 72/231; H04W 72/1268

(52) U.S. Cl. CPC H04B 7/06952; H04B 7/0626; H04B 7/0639; H04W 72/231; H04W 72/1268

(57) ABSTRACT

The present disclosure provides a communication apparatus and a communication method for enhancing uplink transmission with multiple beams. The communication apparatus comprises: a transceiver, which in operation, receives control information indicating two or more beams for uplink transmissions; and circuitry, which in operation, uses the two or more beams for a plurality of uplink transmission occasions in response to meeting at least one condition for beam switching based on the control information.

### TECHNICAL FIELD

The following disclosure relates to communication apparatuses and communication methods for New Radio (NR) communications, and more particularly to communication apparatuses and communication methods for enhancing uplink transmission with multiple beams.

### BACKGROUND

3^{rd} Generation Partnership Project (3GPP) release 15 (Rel. 15), slot (inter-slot) level repetition, i.e., repetition type A, is supported. In repetition type A, different repetitions are transmitted in different slots with same length and starting symbol. Such repetition is applied in physical downlink shared channel (PDSCH), physical uplink control channel (PUCCH) and physical uplink shared channel (PUSCH).

In 3GPP release 16 (Rel. 16), mini-slot (mini-intra-slot) level repetition is supported for PUSCH only, i.e., PUSCH repetition type B. A nominal repetition of PSCH can be divided into multiple actual repetitions based on crossing slot boundary or invalid symbols.

For both PUSCH repetition types A and B, according to current Rel. 15/16 specification, the following observation (observation 1) can be made: All PUSCH repetitions are assumed to use the same uplink (UL) beam and the same set of UL transmission parameters, as shown in FIG. 6. Similarly, for PUCCH repetition, observation 1 still holds true.

According to RAN1#102-e Agreements, the study on performance and specification impacts on time-domain based solution for PUSCH enhancements is prioritized. This study includes: (i) increase the number of repetitions for PUSCH repetition type A, such as PUSCH repetition with non-consecutive slots/on the basis of available slots for time division duplex (TDD), noting that whether increasing the number of PUSCH repetition for frequency division duplex (FDD) depends on the outcome of agenda item 8.8.1,1 from RAN1 chairman's notes: (ii) enhancement on PUSCH repetition Type B, such as actual repetition across the slot boundary or the length of actual repetition larger than 14 symbols, etc.; (in) transport block (TB) processing at least over multi-slot PUSCH, such as single TB sized for a single slot but transmitted in parts over multiple slots, and single TB sized for multiple slots transmitted over multiple slots and in conjunction with repetition, etc.

In the agreement, topics for further study is also discussed such as orthogonal cover code (OCC) spreading based repetition, symbol-level repetition, TB interleaving, redundancy versions (RV) repetition and early termination of PUSCH repetitions.

In Rel. 16, for downlink (DL), multiple physical downlink shared channel (PDSCH) transmission of a TB from different transmission points are supported only. For UL, multiple PUSCH transmission of a TB using different beams are not supported in Rel. 15/16 specification.

Hence, there is a need to address one or more of he above challenges and develop new communication apparatuses and communication methods for enhancing uplink transmission with multiple beams. Furthermore, other desirable features and characteristics will become apparent from the subsequent detailed description and the appended claims, taken in conjunction with the accompanying drawings and this background of the disclosure.

### SUMMARY

One non-limiting and exemplary embodiment facilitates providing communication apparatuses and methods for enhancing UL transmission with multiple beams.

In a first aspect, the present disclosure provides a communication apparatus comprising: a transceiver, which in operation, receives control information indicating two or more beams for uplink transmissions; and circuitry, which in operation, uses the two or more beams for a plurality of uplink transmission occasions in response to meeting at least one condition for beam switching based on the control information.

In a second aspect, the present disclosure provides a communication method, comprising: receiving control information indicating two or more beams for uplink transmissions; and using the two or more beams for a plurality of uplink transmission occasions in response to meeting at least one condition for beam switching based on the control information.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for radio resource control (RRC) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 shows exemplary physical uplink shared channel (PUSCH) repetition types A and B, where same uplink (UL) beam is applied for all PUSCH repetitions.

FIG. 7 shows a schematic diagram illustrating an example blockage of one of multiple beams for uplink transmission.

FIG. 8 shows a schematic example of communication apparatus in accordance with various embodiments. The communication apparatus may be implemented as a UE or a gNB/base station and configured for enhancing uplink transmission with multiple beams in accordance with various embodiments of the present disclosure.

FIG. 9 shows a flow diagram illustrating a communication method for enhancing uplink transmission with multiple beams in accordance with various embodiments of the present disclosure.

FIG. 10 shows a FUSCH repetition type A for which two beams is used according to a first example of a first embodiment of the present disclosure.

FIG. 11 shows a schematic diagram illustrating two beams mapped to two repetitions from FIG. 10 under a scenario of multiple TRP (Transmission Reception Point) transmission according to the first example of the first embodiment of the present disclosure.

FIG. 12 shows an example configuration of a time-domain resource assignment/allocation for beam switching for a plurality of uplink transmission occasions according to the first embodiment of the present disclosure.

FIG. 13 shows an example configuration of a new invalid symbol in uplink transmission occasions under PUSCH repetition type B according to a second embodiment of the present disclosure.

FIG. 14A shows a PUSCH repetition type B with Rel. 16 invalid symbols.

FIG. 14B shows a PUSCH repetition type B with new invalid symbols according to an example of the second embodiment of the present disclosure.

FIG. 15A shows a PUSCH repetition type B with Rel. 16 invalid symbols.

FIG. 15B shows a PUSCH repetition type B with Rel. 16 invalid symbols and new invalid symbols according to another example of the second embodiment of the present disclosure.

FIG. 15C shows a PUSCH repetition type B with Rel. 16 invalid symbols and new invalid symbols according to yet another example of the second embodiment of the present disclosure.

FIG. 16 shows an example symbol level repetition according to a third embodiment of the present disclosure.

FIG. 17 shows an example PUSCH allocation configuration for beam switching for a plurality of uplink transmission occasions according to the third embodiment of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones. The second version of the 5G standard was completed in June 2020, which further expand the reach of 5G to new services, spectrum and deployment such as unlicensed spectrum (NR-U), non-public network (NPN), time sensitive networking (TSN) and cellular-V2X.

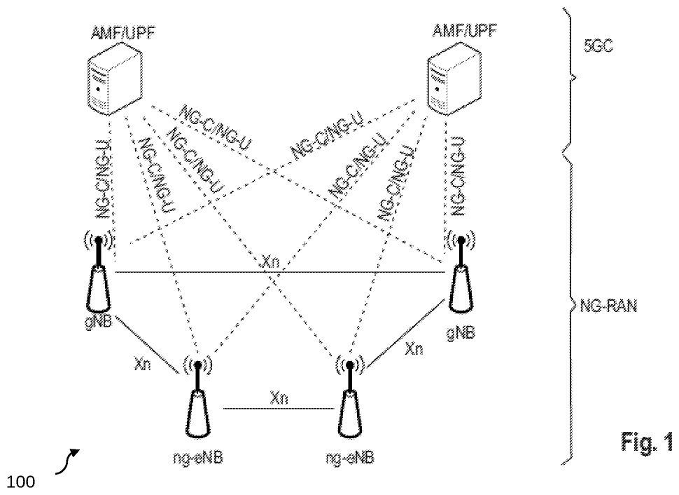

Among other things, the overall system architecture assumes an NG-RAN (Next Generation—Radio Access Network) that comprises gNBs, providing the NG-radio access user plane (SDAP/PDCPIRLC/MACIPHY) and control plane (RRC) protocol terminations towards the UE. The gNBs are interconnected with each other by means of the Xn interface. The gNBs are also connected by means of the Next Generation (NO) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0).

The user plane protocol stack for NR (see e.g. 3GPP TS 38.300, section 4.4.1) comprises the PDCP (Packet Data Convergence Protocol, see section 6.4 of TS 38.300). RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY hybrid automatic repeat request (HARQ) processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink, PDSCH (Physical Downlink Shared Channel), PDCCH (Physical Downlink Control Channel) and PBCH (Physical Broadcast Channel) for downlink, and PSSCH (Physical Sidelink Shared Channel), PSCCH (Physical Sidelink Control Channel) and Physical Sidelink Feedback Channel (PUSCH) for sidelink (SL).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

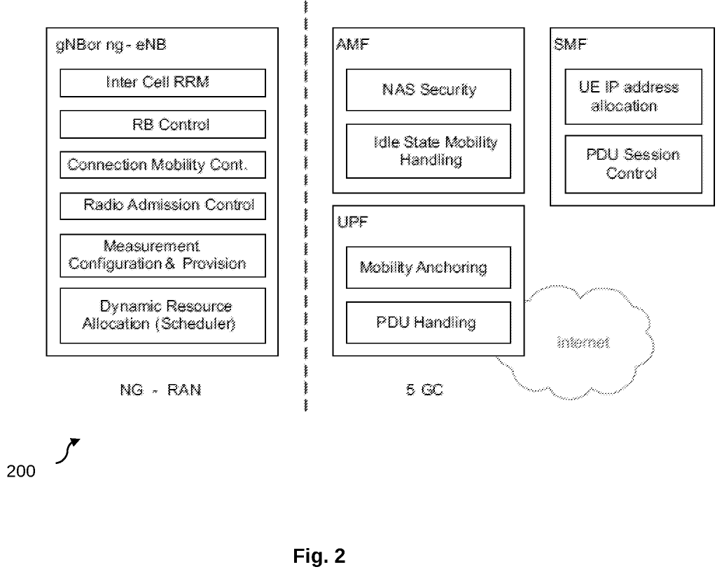

FIG. 2 illustrates functional split between NG-RAN and 5GC. NG-RAN logical node is a gNB or ng-eNB, The 5GC has logical nodes AMF, UPF and SMF.

In particular, the gNB and ng-eNB host the following main functions:
Functions for Radio Resource Management such as Radio Bearer Control,
Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;

Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers; Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, ON, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

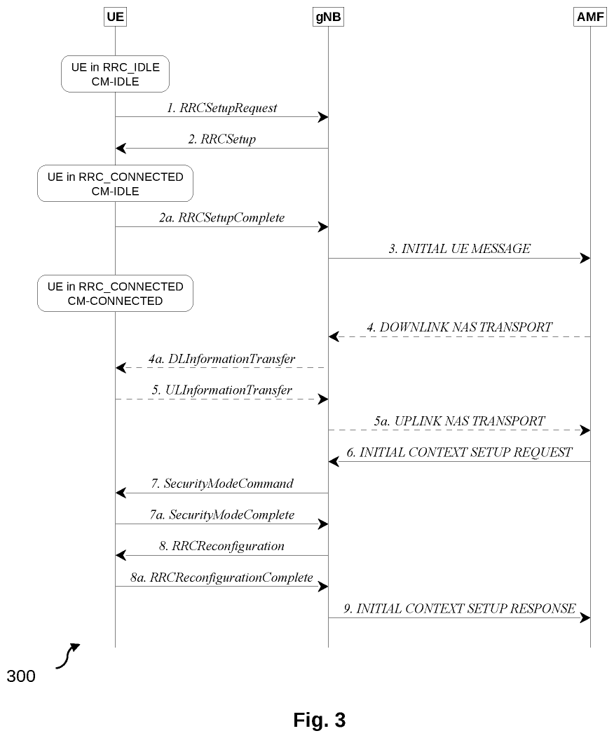

FIG. 3 illustrates some interactions between a UE, qNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure. NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502.
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DREs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

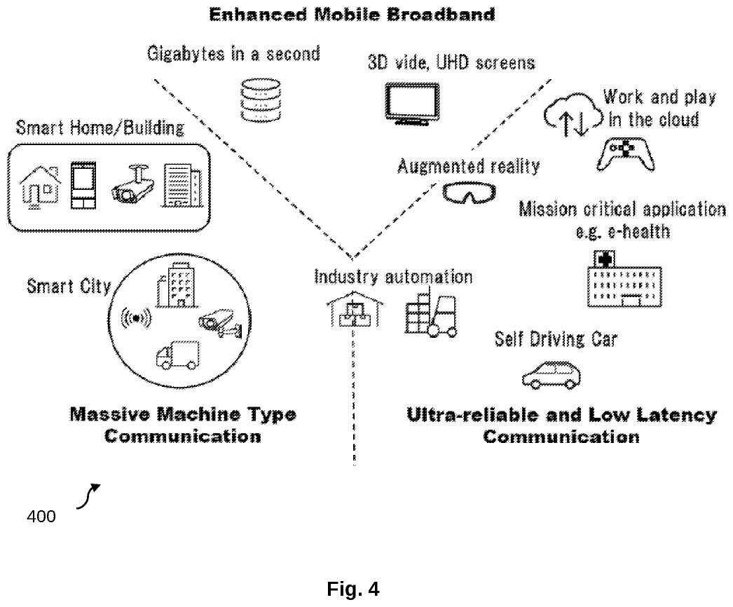

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1 E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non-slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements, Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated COI/MOS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios,

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few ps where the value can be one or a few ps depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot (or intra-slot) level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g., as shown above with reference to FIG. 3. The NG-RAN maps packets belonging to different PDU sessions to different DRBs, NAS level packet filters in the UE and in the 5GC associate UL and DL packets with QoS Rows, whereas AS-level mapping rules in the UE and in the NG-RAN associate UL and DL QoS Rows with DRBs.

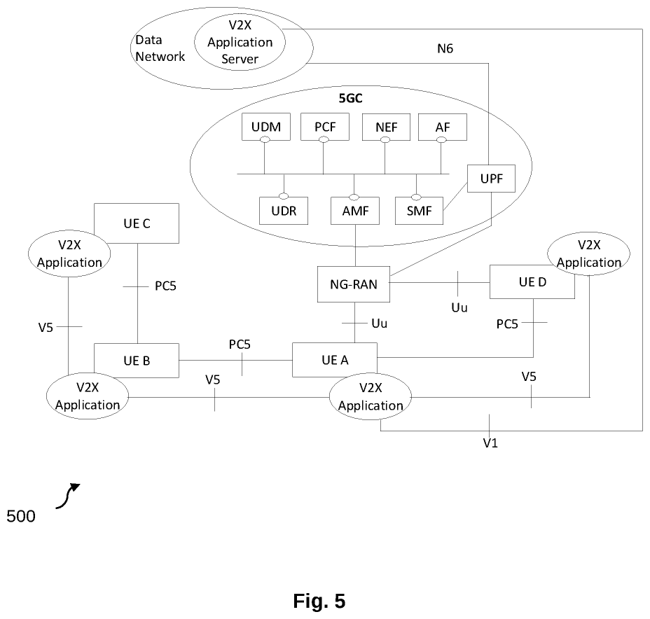

FIG. 5 illustrates a 5G NR non-roaming reference architecture (see TS 23.287 v16.4.0, section 4.2.1.1). An Application Function (AF), e.g., an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the SGC, as well as with V2X Application Server (V2AS) and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF,UPF, etc) of the 5GC to establish a PDU session including a radio bearer between a gNodeB and a UE in accordance with the QoS requirement and control circuitry, which, in operation, performs the services using the established PDU session.

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

In the present disclosure, the base station may be a Transmission Reception Point (TRP), a cluster head, an access point, a Remote Radio Head (RRH), an eNodeB (eNB), a uNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

The present disclosure may be applied to any of uplink, downlink and sidelink. The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

In the present disclosure, the reference signals are signals known to both a base station and a mobile station and each reference signal may be referred to as a Reference Signal (RS) or sometimes a pilot signal. The reference signal may be any of a DMRS, a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precodine vector weighting. It will be understood that while some properties of the various embodiments have been described with reference to a device, corresponding properties also apply to the methods of various embodiments, and vice versa.

There is a need to address one or more of the above challenges and develop new communication apparatuses and communication method for enhancing uplink transmission with multiple beams, in particular, to enhance: (i) performance of the cell-edge UE or UE in coverage enhancement regions; (ii) use cases of these UEs; (iii) beam-orientated operations in 5G (or beam managements); (iv) multiple TRP transmission operation. Other desirable features and characteristics will become apparent from the subsequent description and the appended claims, taken in conjunction with the accompanying drawings and this background of the disclosure.

In various embodiments below, an uplink transmission occasion refers to a nominal/actual repetition or a group/set of nominal/actual repetitions, where a nominal/actual repetition could be one or more consecutive symbols.

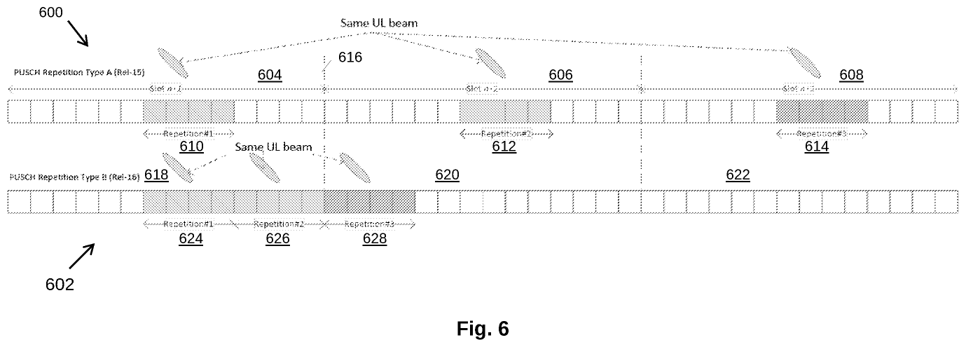

FIG. 6 shows exemplary PUSCH repetition type A 600 and PUSH repetition type B 602, where same UL beam is applied for all PUSCH repetitions. As mentioned above, in Rel. 15, different repetitions 610, 612, 614 are transmitted in different slots 604, 606, 608 with same length and starting symbol; whereas in Rel. 16, a nominal repetition of PUSCH can be divided into multiple actual repetitions 624, 626, 628 based on crossing slot boundary 616 or invalid symbols (not shown). All PUSCH repetitions are assumed to use the same UL beam (i.e. spatial relation information) and the same set of UL transmission parameters in accordance with the observation 1 in the current Rel. 15/16 specification.

One of major technical challenges employing high frequency bands for 5G new radio (NR) networks is the serious human/building blockage, which causes the shadow fading and penetration loss. For example, human blockage can cause attenuation of propagation channel as large as 30-40 dB. Since the same UL beam is used for all PUCCH/PUSCH repetitions, it is possibly blocked by human bodies, resulting in degradation of coverage and reliability significantly. To overcome blockage, multiples beam can be used for the PUCCH/PUSCH repetitions, However, how to handle latency aspect for beam switching is still an open issue to support the PUCCH/PUSCH repetitions with multiple beams.

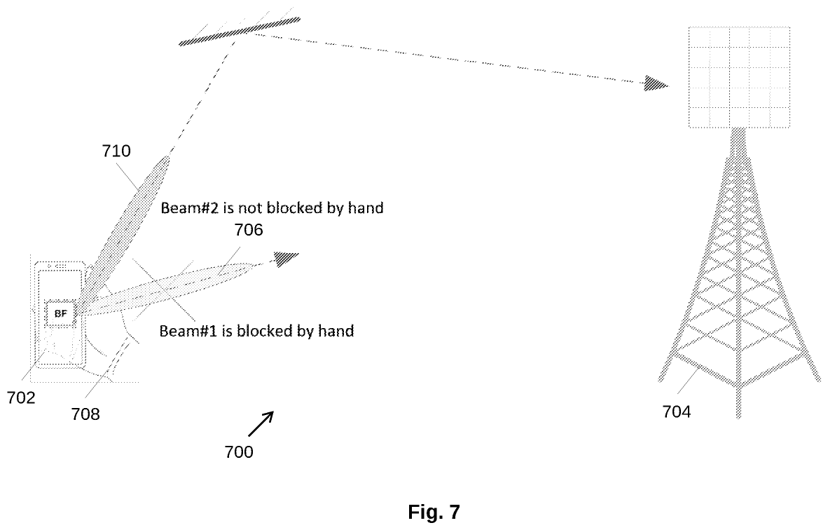

FIG. 7 shows a schematic diagram 700 illustrating an example blockage of one of multiple beams for uplink transmission. A UE (e.g. mobile device) 702 may initiate an UL transmission to a base station 704. The UL transmission via beam 1 706 may be blocked by human hand 708 such that the UL transmission fails, while beam 2 710 is not blocked by the human hand 708 and therefore could reach the base station 704. Hence, beam 2 710 can be used for the UL transmission.

Hence, there is a need to address one or more of the above challenges and develop new communication apparatuses and communication methods for enhancing uplink transmission with multiple beams. According to the present disclosure, a UE is configured to use two or more beams to transmit a plurality of uplink transmission occasions in response to meeting at least one condition. The at least one condition relating to at least one of a network explicit indication and a required latency of beam switching. Advantageously, this would improve the performance on the coverage and reliability of uplink transmissions using multiple beams.

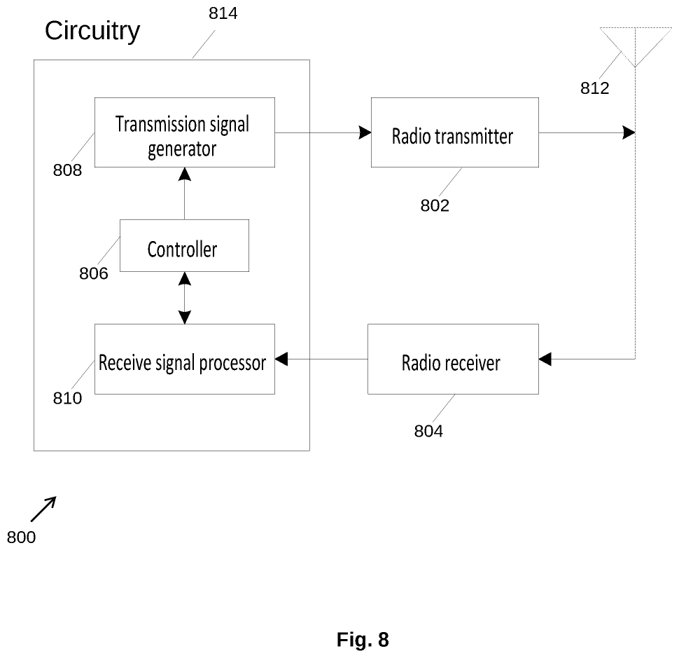

FIG. 8 shows a schematic example of communication apparatus in accordance with various embodiments. The communication apparatus may be implemented as a UE or a uNB/base station and configured for enhancing uplink transmission with multiple beams in accordance with various embodiments of the present disclosure.

As shown in FIG. 8, the communication apparatus 800 may include circuitry 814, at least one radio transmitter 802, at least one radio receiver 804, and at least one antenna 812 (for the sake of simplicity, only one antenna is depicted in FIG. 8 for illustration purposes). The circuitry 814 may include at least one controller 806 for use in software and hardware aided execution of tasks that the at least one controller 806 is designed to perform, including control of communications with one or more other communication apparatuses in a wireless network. The circuitry 814 may furthermore include at least one transmission signal generator 808 and at least one received signal processor 810. The at least one controller 806 may control the at least one transmission signal generator 808 for generating signals (for example, baseband signals) to be sent through the at least one radio transmitter 802 to one or more other communication apparatuses (e.g. base communication apparatuses) and the at least one receive signal processor 810 for processing signals (for example, baseband signals) received through the at least one radio receiver 804 from the one or more other communication apparatuses under the control of the at least one controller 806. The at least one transmission signal generator 808 and the at least one received signal processor 810 may be stand-alone modules of the communication apparatus 800 that communicate with the at least one controller 806 for the above-mentioned functions, as shown in FIG. 8. Alternatively, the at least one transmission signal generator 808 and the at least one received signal processor 810 may be included in the at least one controller 606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 602, at least one radio receiver 804, and at least one antenna 812 may be controlled by the at least one controller 806.

In various embodiments of the present disclosure, a radio transmitter 802 and a radio receiver 804 may together be referred to as a transceiver. As such, the communication apparatus 800 may comprise at least one transceiver for transmitting and receiving signals through the at least one antenna 812.

The communication apparatus 600, when in operation, provides functions required for enhancing uplink transmission with multiple beams. For example, the communication apparatus 600 may be a UE, and the at least one radio receiver 804 may, in operation, receives control information indicating two or more beams for uplink transmission, and the circuitry 614 may, in operation, uses the two or more beams for a plurality of uplink transmission occasions in response to meeting at least one condition for beam switching based on the control information.

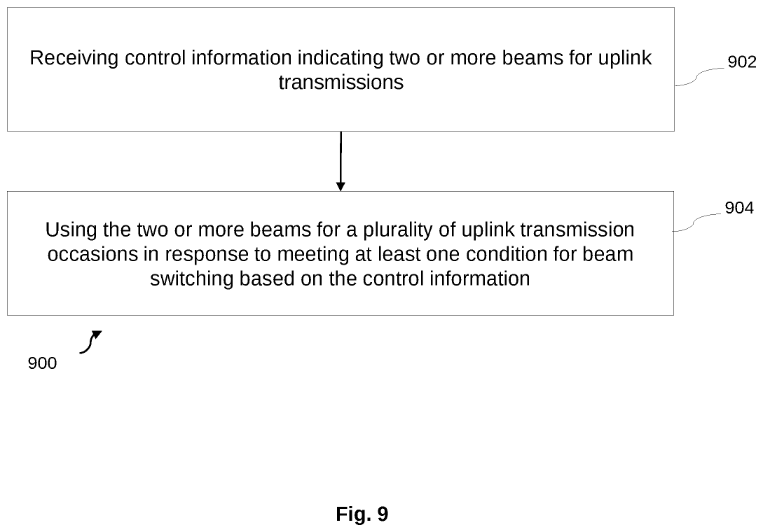

FIG. 9 shows a flow diagram 900 illustrating a communication method for enhancing uplink transmission with multiple beams in accordance with various embodiments of the present disclosure. In step 902, a step of receiving control information indicating two or more beams for uplink transmission is carried out. In step 904, a step of using the two or more beams for a plurality of uplink transmission occasions in response to meeting at least one for beam switching is carried out.

In the following paragraphs, certain examples relating to a first embodiment of the present disclosure are explained with reference to a UE for uplink transmission with multiple beams, especially under PUSCH repetition type A with multiple beams.

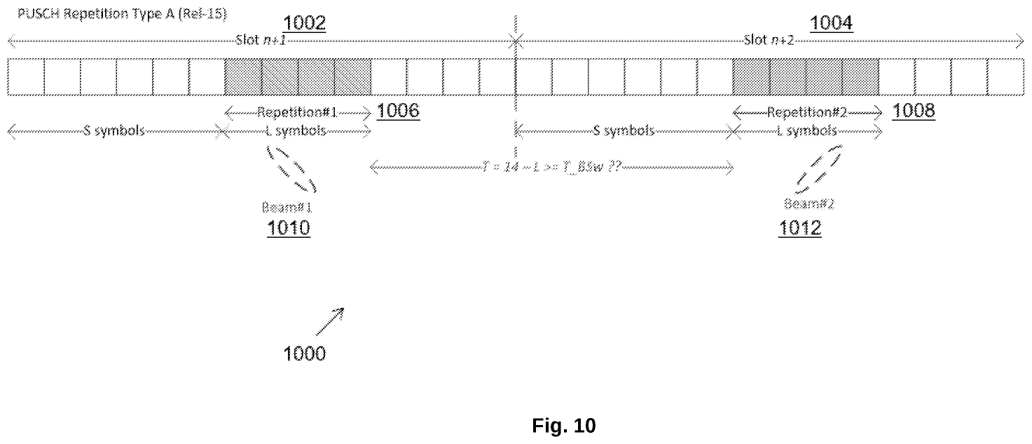

FIG. 10 shows a PUSCH repetition type A for which two beams is used according to a first example of a first embodiment of the present disclosure. Under PUSCH repetition type A, different transmission occasions (e.g. repetitions 1006, 1008) are transmitted in different slots 1002, 1004 respectively with same length and starting symbol. In this embodiment, beam switching among multiple beams is applied if the interval (T) between two consecutive transmission occasions (e.g. repetitions 1006, 1008 in consecutive slots 1002, 1004) is not less than the required latency of beam switching (T_{BSw}) from the UE. The interval can be calculated using equation (1) and the above condition of T in relation to T_{BSw} can be expressed using equation (2):

T=14−L equation (1)

T≥T_{BSw} equation (2)

where L is the length of each repetition, T is the interval between two consecutive transmission occasions (in this case 1006, 1008) and T_{BSw} is the required latency of beam switching.

In response to meeting the condition expressed in the equation (2), that is, repetition#1 1006 and repetition#2 1008 have an interval larger than the required latency of beam switching (T=14−L≥T_{BSw}), two beams (beam#1 1010 and beam#2 1012 are then configured to be used for transmitting the repetition#1 1006 and the repetition#2 1008 respectively.

In an embodiment, a decision of beam switching is made by a base station gNB. In such embodiment, a new explicit indication is indicated this decision to the UE by using at least one of a downlink control information (DCI) signaling, a medium access control layer control element (MAC CE) signaling, or a radio resource control (RRC) signalling. Instead of using {S, L} or {SLIV} specified in Rel. 15/16 specification where S is the starting symbol of a PUSCH allocation, L is the length of each repetition and SLIV is start length indicator, in the new explicit indication, time-domain resource assignment (TDRA) is defined based on {S, L, 14−L≥T_{BSw}} or {SLIV, 14−T_{BSw}} by gNB. Additionally or alternatively, DCI is used to indicate TDRA values.

Beam switching might be applicable within each slot (e.g. slot 1002, slot 1004). In other words, inter-slot level beam switching and mapping are applicable per slot. A cyclical beam mapping pattern may be used, as shown in FIG. 10, that is, a first beam, e.g. beam#1 1010, and a second beam, .e.g. beam#2 1012, are applied to a first repetition, e.g repetition #1 1006, and a second repetition, e.g. repetition#2 1008 of the slot respectively. Assuming there is no beam other than the first beam 1010 and the second beam 1012, and the first beam and the second beam will be applied to a third repetition and a fourth repetition (not shown), respectively. The same beam mapping pattern continues for the remaining repetitions.

In a first variation of the first embodiment, a subset of {S, L} or {SLIV}, which is specified in a sub-clause 5.1.2.1 regarding resource allocation in time-domain in 3GPP technical specification (TS) 38.214, satisfying the condition expressed in equations (1) and (2) can be configured.

In a second variation of the first embodiment, instead of the cyclical beam mapping pattern, a sequential mapping pattern is used. For example, the first beam 1010 is applied to the first and second repetitions 1006, 1008, and the second beam 1012 is applied to the third and fourth repetitions (not shown). A third beam (not shown) may be applied to the fifth and sixth repetition (not shown). The same beam mapping pattern continues for the remaining repetitions.

In a third variation of the first embodiment, instead of the cyclical beam mapping pattern, a half-half mapping pattern is used. In particular, if there are a total of four repetitions in the PUSCH, the first beam 1010 is applied to the first halt of the four repetitions, i.e., first and second repetitions, while the second beam 1012 is applied to the second half of the four repetitions, i.e., third and fourth repetitions.

In a fourth variation of the first embodiment, instead of the cyclical beam mapping pattern, a usage of each of the multiple beams, i.e., the first beam 1010 and the second beam 1012 for the multiple repetitions is configurable. This beam mapping pattern may be referred to as configurable beam mapping pattern.

In a fifth variation of the first embodiment, the interval between two consecutive repetitions is determined based on a length of each repetition.

In a sixth variation of the first embodiment, if the interval between two consecutive repetitions is less than the required latency of beam switching, and thus the condition is not met, only one of the multiple beams will be used to transmit the multiple repetitions.

In a seventh variation of the first embodiment, if the interval between two consecutive repetitions is less than the required latency of beam switching, and thus the condition is not met, where the first beam is the strongest beam among multiple beams, other repetitions that are mapped to beam(s) other than the first beam will be dropped such that only repetition(s) mapped to the first beam are transmitted.

In an eighth variation of the first embodiment, for PUSCH repetition in non-consecutive slots, e.g. the first slot 1002 and third slot (not shown) next to the second slot 1004, if the interval between two consecutive repetitions is less than the required latency of beam switching, and thus the condition is not met, where the first beam is the strongest beam among multiple beams, the repetitions that are mapped to beam(s) other than the first beam will be postponed or shifted, until the condition is met, that is, the interval between the two consecutive repetitions is not less than the required latency of beam switching.

In a ninth variation of the first embodiment, in reference to the seventh and eighth variations, the first beam can be the configured beam with a smallest index.

In a tenth variation of the first embodiment, the interval between two consecutive repetitions is different among UEs.

In an eleventh variation of the first embodiment, the slot may be a virtual slot comprising a number of consecutive virtual symbols in symbol-level repetition framework, where a virtual symbol contains a number of consecutive symbols.

Further, a sequential mapping pattern and a half-half mapping pattern may be used in mapping repetitions of virtual symbols over virtual slots.

In a twelfth variation, the length of a repetition of PUSCH allocation can be shorter for the multiple beams.

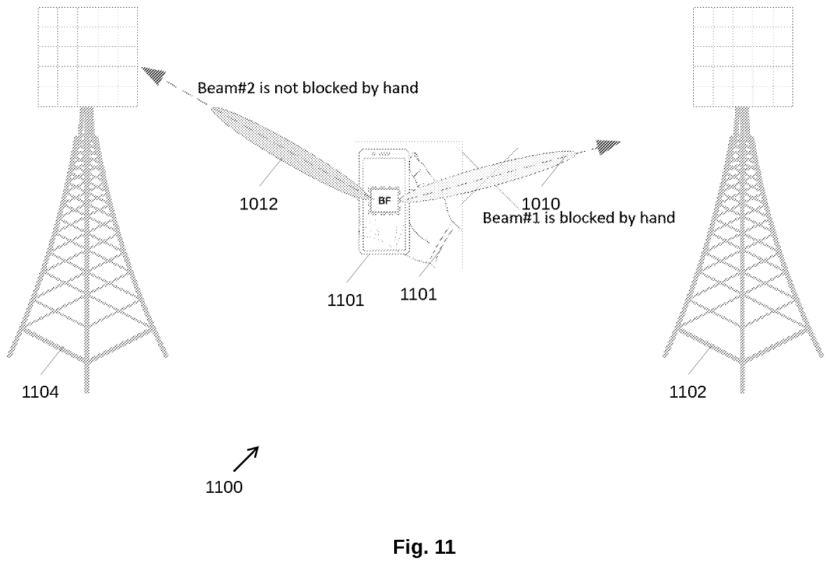

It is noted that the uplink transmission occasions using multiple beams described above can be directly in single and multiple in single or multi-TRP (Transmission Reception Point) transmission scenario. For single TRP, the first beam 1010 and the second beam 1012 are used for the first repetition 1006 and the second repetition 1008, respectively; whereas for multiple TRP, both of the first beam 1010 and the second beam 1012 are used to map both of the first repetition 1006 and the second repetition 1008. FIG. 11 shows a schematic diagram illustrating two beams mapped to two repetitions from FIG. 10 under a scenario of multiple TRP (Transmission Reception Point) transmission according to the first example of the first embodiment of the present disclosure. The UE 1101 may transmit signal, via a first beam, e.g., beam#1 1010, and a second beam, e.g., beam#2 1012, to a first base station 1102 and a second base station 1104, respectively. The beam#1 and beam#2 in the schematic diagram 1100 in FIG. 11 that are the same as the beam#1 and beam#2 in FIG. 10 are denoted using the same reference numerals in the drawings, and descriptions thereof are omitted.

Under multiple TRP transmission scenario, the UE may be configured to use bearn#1 1010 and beam#2 1012 for all repetitions, e.g., the first repetition 1006 and the second repetition 1008. In this scenario, even if beam#1 1010 is blocked by hand 1106 and could not reach the intended first base station 1102, the repetitions 1006, 1008 may successfully be transmitted via beam#2 1012 to the second base station 1104.

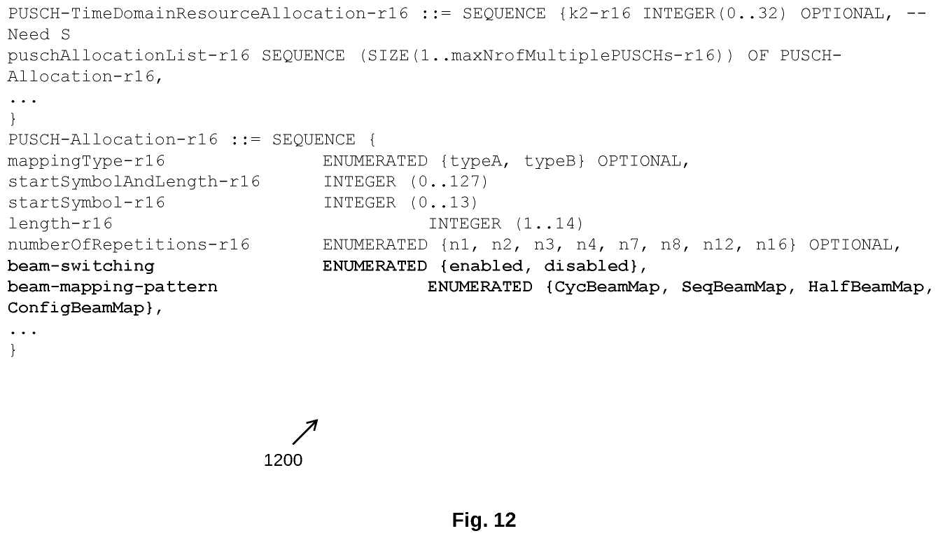

FIG. 12 shows an example configuration 1200 of a time-domain resource assignment/allocation for beam switching for a plurality of uplink transmission occasions according to the first embodiment of the present disclosure. PUSCH-Allocation-r16 in PUSCH-TimeDomainResourceAllocation is enhanced to indicate beam switching by adding new entry beam-switching. When beam-switching is enabled and the value indicated by numberOfRepetition0r16 is larger than one, the UE may be further configured to enable one of beam mapping patterns in beam-mapping-pattern, where CycBeamMap, SeqBeamMap, HalfBeamMap, ConfigBeamMap denote the cyclical beam mapping patter, sequential beam mapping, half-half beam mapping pattern and configurable beam mapping pattern, respectively.

According to a second example of the first embodiment of the present disclosure, a new explicit indication for allowing beam switching may be used to indicate to a UE. In such case, unlike the first example, a decision of beam switching is made by the UE if the interval between two consecutive repetitions is not less than the required latency of beam switching, for example, expressed in equations (1) and (2). Otherwise, beam mapping and switching are not applicable. The new explicit indication is indicated using at least one of a DCI signalling, a

MAC CE signalling and a RC signalling. When the new explicit indication is configured by gNB, the UE understands that the gNB supports beam mapping based on current TDRA for a repetition of PUSCH allocation is used based on {S, L} or {SLIV} specified in Rel. 15/16 technical specifications.

Similar to the first example, any one of the beam mapping patterns such as

cyclical beam mapping pattern, sequential beam mapping pattern, half-half beam mapping pattern and configurable beam mapping pattern may be used in the second example.

To perform the operation of the second example of the first embodiment, firstly, when a UE receives control information and the new explicit indication for allowing beam switching from a gNB, the UE may determine starting symbol S and allocation length L for a repetition of PUSCH allocation from current TDRA configuration and the new explicit indication for allowing beam switching; and secondly, up to capabilities of the UE, the required latency of beam switching T_{BSw}, the UE decides whether to perform actual beam switching if the condition expressed in equations (1) and (2) is met. The UE understands that gNB support beam mapping based on the new indication, The UE may further configured to provide an assistance information to the gNB based on the UE's capabilities where the assistance information includes at least beam mapping pattern, preferences of the required latency of beam switching, processing timeline parameters, antenna configuration, bandwidth parts, channel state information measurements, and/or spatial information. Such assistance information is provided in order to be used in a subsequent configuration for the UE adaption to perform uplink transmission effectively.

Notably, the difference between the first example and the second example of the first embodiment of the present disclosure is that the decision of beam switching is made by gNB in the first example, whereas the decision of beam switching is made by UE in the second example. Beam switching is applicable within each slot in the first example, whereas it may not be applicable in the second example due to derivation of TDRA including S and L for a repetition of PUSCH. TDRA is defined based on {S, L, 14−L≥T_{BSw}} or {SLIV, 14−L≥T_{BSw}} in the first example; whereas {S, L} or {SLIV} in the second example.

In the following paragraphs, certain examples relating to a second embodiment of the present disclosure are explained with reference to a UE for uplink transmission with multiple beams, especially under PUSCH repetition type B with multiple beams.

Under PUSCH repetition type B, a nominal repetition of PUSCH can be divided into multiple actual repetitions based on crossing slot boundary or invalid symbols. According to the second embodiment, to enable beam switching among multiple beams for PUSCH repetition type B, T_{BSw} is taken into account to define new invalid symbols by UE.

In a first example of the second embodiment, the new invalid symbols is configured according to the following equation (3):

new_invalid_symbol=max {Rel.16_invalid_symbols, T_{BSw}} equation (3)

where Rel.16 invalid symbols are Rel.16 invalid symbols indicated by using tdd-UL-DL-ConfigurationCommon/tdd-UL-DLConfigurationDedicated, or ssb-PositionsInBurst/ssb-PositionsInBurst, or numbednvalidSymboisForDLUL-Switching, or invalidSymbolPattem, etc.

According to 3GPP TS 38.214 v16.2.0 sub-clause 6.1.2.1, if an UE is configured with multiple serving cells and is provided half-duplex-behaviour-r16 is “enable”; and is not capable of simultaneous transmission and reception on any of the multiple serving cells, and indicates support of capability for half-duplex operation in CA with unpaired spectrum, and is not configured to monitor PDCCH for detection of DCI format 2-0 on any of the multiple serving cells, a symbol is considered as an invalid symbol in any of the multiple serving cells for PUSCH repetition type B transmission if the symbol is indicated to the UE for reception of SSIPBCH blocks in any of the multiple serving cells by ssb-PositionsInBurst in SIB1 or ssb-PositionlnBurst in ServingCellConfigCommon; and a symbol is considered as an invalid symbol in any of the multiple serving cells for PUSCH repetition type B transmission with Type 1 or Type 2 configured grant except for the first Type 2 PUSCH transmission (included all repetition) after activation if the symbol is indicated as downlink by tdd-UL-DL-ConfigurationCommon or tdd-UL-DL-ConfigurationDedicated on the reference cell, or the UE is configured by higher layers to receive PDCCH, PDSCH, or CSI-HS on the reference cell in the symbol.

For PUSCH repetition type B, after determining the invalid symbol(s) for PUSCH repetition type B transmission for each of the K nominal repetitions, the remaining symbols are considered as potentially valid symbols for PUSCH repetition type B transmission, If the number of potentially valid symbols for PUSCH repetition type B transmission is greater than zero for a nominal repetition, the nominal repetition consists of one or more actual repetitions, where each actual repetition consists of a consecutive set of all potentially valid symbols that can be used for PUSCH repetition type B transmission within a slot. An actual repetition with single symbol is omitted except for the case of L-1. An actual repetition is omitted according to the condition in Clause 11, 1 of TS 38.213. The redundancy version to be applied on the nth actual repetition (with the counting including the actual repetitions that are omitted) is determined according to table 2.

For PUSCH repetition type B, when a UE receives a DCI that schedule aperiodic CSI report(s) or activates semi-persistent CSI report(s on PUSCH with no transport block by a CSI request field on a DCI, the number of nominal repetitions is always assumed to be 1, regardless of the value of numberofrepetitions. When the UE is scheduled to transmit a PUSCH repetition type B with no transport block and with aperiodic or semi-persistent SCI report(s) by a SCI request field on a DCI, the first nominal repetition is expected to be same as the first actual repetition. For PUSCH repetition type B carrying semi-persistent SCI report(s) without a corresponding PDCCH after being activated on PUSCH by a CSI request field on a DCI, if the first nominal repetition is not the same as the first actual repetition, the first nominal repetition is omitted; otherwise, the first nominal repetition is omitted according to the conditions in Clause 11.1 of TS 38.213.

For PUSCH repetition type B, when a UE is scheduled to transmit a transport block and aperiodic CSI reports) on PUSCH by a CSI request field on a DCI, the CSI report(s) is multiplexed only on the first actual repetition. The UE does not expect that the first actual repetition has a single symbol duration.

If pusch-TimeDomainAllocationList in punch-Config contains row indicating

resource allocation for two to eight contiguous PUSCHs, K₂ indicates the slow where UE shall transmit the first PUSCH of the multiple PUSCHs, Each PUSCH has a separate SLIV and mapping type. The number of scheduled PUSCHs is signalled by the number of indicated valid SLIVs in the row of the pusch-TimeDomainAllocationList signalled in DCI format 0_1.

When the UE is configured with minimumSchedulingOffsetK2 in an active UL BWP (bandwidth part) it applies a minimum scheduling offset restriction indicated by the ‘Minimum applicable scheduling offset indicator’ field in DCI format 0_1 or DCI format 1_1 if the same field is available. When the UE configured with minimumSchedulingOffSetK2 in an active UL BWP and it has not received ‘Minimum applicable scheduling offset indicator’ field in DCI format 0_1 or 1_1, the UE shall apply a minimum scheduling offset restriction indicated based on ‘Minimum applicable scheduling offset indicator’ value ‘0’. When the minimum scheduling offset restriction is applied the UE is not expected to be scheduled with a DCI in slow n to transmit a PUSCH scheduled with C-RNTI, CS-RNTI, MCS-C-RNTI or SP-CSI-RNTI with K₂ smaller than

$${K}_{2 min} \cdot \frac{{2}^{{μ}^{′}}}{{2}^{μ}} ,$$

where K₂ₘᵢₙ and μ are the applied minimum scheduling offset restriction and the numerology of the active UL BWP of the scheduled cell when receiving the DCI in slow n, respectively, and μ′ is the numerology of the new active UL BWP in case of active UL BWP change in the scheduled cell and is equal to μ, otherwise. The minimum scheduling restruction is not applied when PUSCH transmission is scheduled by RAR UL grant or fallbackRAR UL grant for RACH procedure, or when PUSCH is scheduled with TC-RNT1. The application delay of the change of the minimum scheduling offset restriction is determined in Clause 5.3.1.

In the first example of the second embodiment, such new invalid symbols according to equation (3) is applied to every occasion or event of Rel. 16 invalid symbols. In particular, an occasion or event can include a single one or more Rel. 16 consecutive invalid symbols. Such new_invalid_symbols can be indicated to the UE by using at least a DCI signalling, a MAC CE signalling and a RC signalling.

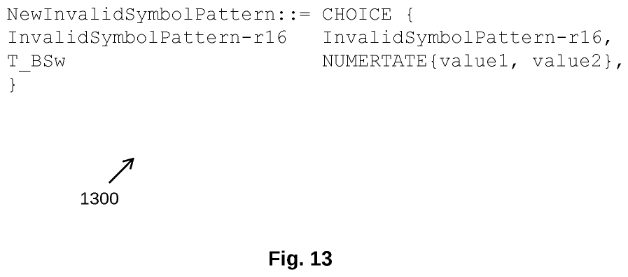

FIG. 13 shows an example configuration of a new invalid symbol in uplink transmission occasions under PUSCH repetition type B according to a second embodiment of the present disclosure. NewInvalidStmbolPattern and T_BSw are additionally proposed, where value1 and value2 correspond to durations of 3 and 6 symbols and invaildSymbolPattern-r16 is specified in Rel.16.

After application of new invalid symbols to every occasion or event of Rel.16 invalid symbols in the PUSCH repetition type B, nominal/actual repetitions of PUSCH repetition type B are now based on the new invalid symbols. Nominal repetitions of PUSCH is divided into multiple actual repetitions based on the new invalid symbol(s). Each of multiple beams may be used for a group of actual repetitions. Beam switching among multiple beams is applied during the time occupied by the new invalid symbol. Similarly, in this embodiment, any one of the beam mapping patterns such as cyclical beam mapping pattern, sequential beam mapping pattern, half-half beam mapping pattern and configurable beam mapping pattern may be used.

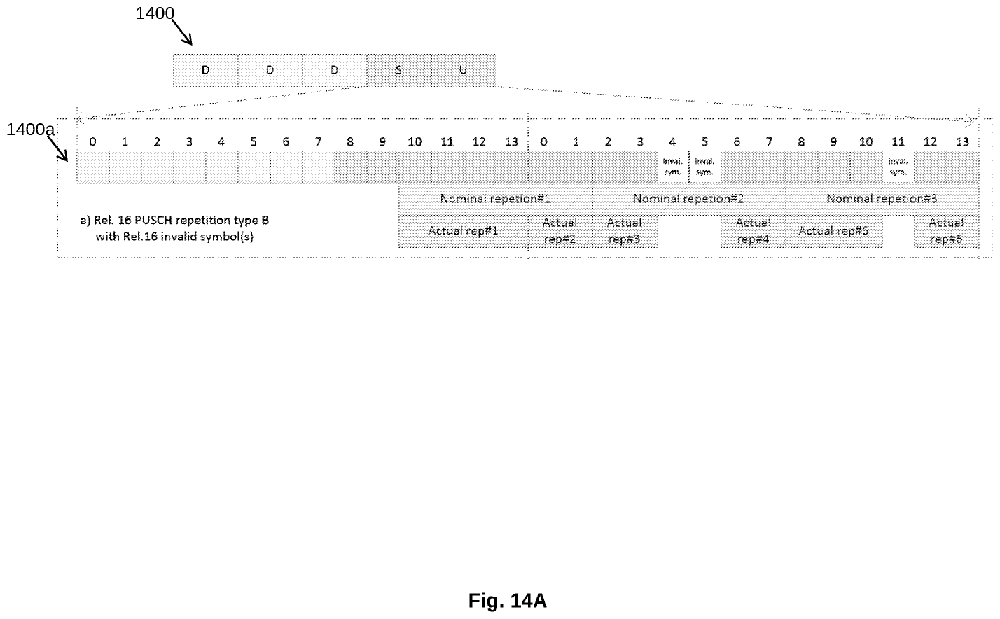

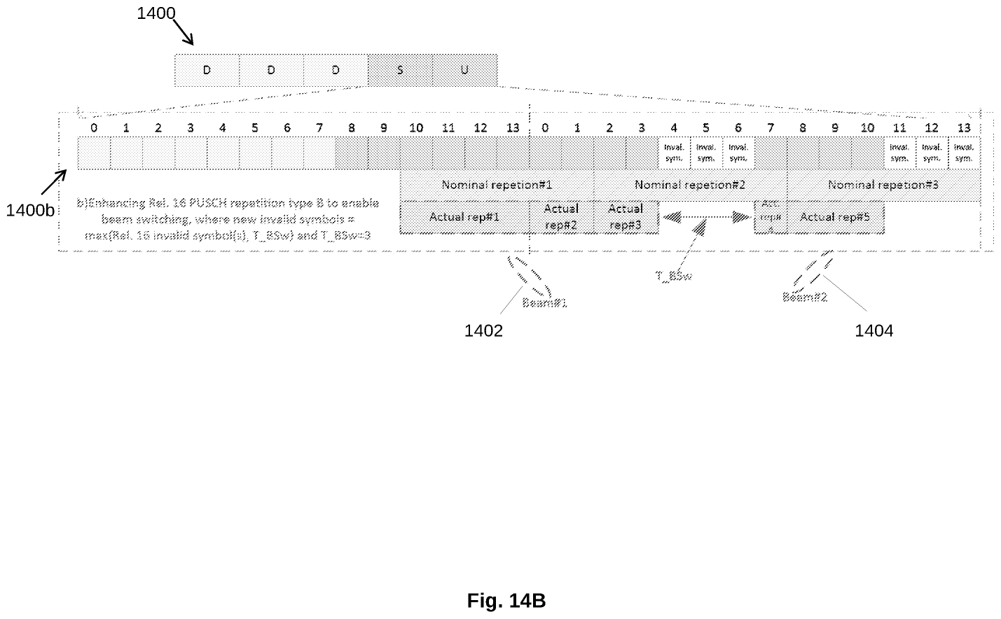

FIG. 14A shows a PUSCH repetition type B 1400a with Rel. 16 invalid symbols. In FIG. 14A, UE determines six actual repetitions #1-6 from three nominal repetition #1-3 based on Rel. 16 (legacy) invalid symbols, e.g. symbols #4-5 and symbol #11 in a UL slot.

In this example, new invalid symbols are determined based on a single one (e.g. Rel. 16 invalid symbols at symbol #11 in FIG. 14A) or more consecutive legacy invalid symbols (e.g. Rel. 16 (legacy) invalid symbols at symbols #4-5 in FIG. 14A). FIG. 14B shows a PUSCH repetition type B with 1400b with new invalid symbols according to an example of the second embodiment of the present disclosure.

Assuming it is determined that T_{BSw} has a value of three symbols, three new invalid symbols at symbols #4-6 and at symbols #11-13 are determined for the 1^{st} occasion/event (based on consecutive Rel. 16 invalid symbols at symbols #4-5) and the 2^{nd} occasion/event (based on a single Rel. 16 invalid symbol at symbol#11) respectively in the UL slot.

With the new invalid symbols, the UE determines five actual repetitions #1-5 from the three nominal repetitions #1-3. Such introduction of new invalid symbol may create an interval between two actual repetitions not less than the required latency of beam switching and thus enable beam switching. Beam switching among multiple beams can be applied during the time occupied by the new invalid symbols, in this case, at symbols #4-6, where a first beam beam#1 1402 is used for a group of actual repetitions #1-3 and a second beam beam#2 1404 is used for a group of actual repetitions #4-5.

According to a second example of the second embodiment, the new invalid symbols is configured according to the following equation (4):

new_invalid_symbol={Rel.16_invalid_symbols, T_{BSw}} equation (4)

where Rel.16_invalid_symbols are Rel.16 invalid symbols indicated by using tdd-UL-DL-ConfigurationCommon/tdd-LJL-DLConfigurationDedicated, or ssb-PositionsInBurst/ssb-PositionsInBurst, or numberInvalidSymboisForDL-UL-Switching, or InvalidSymbolPattern, etc, as specified in Sub-clause 6.1.2.1 of technical specification 38.214.

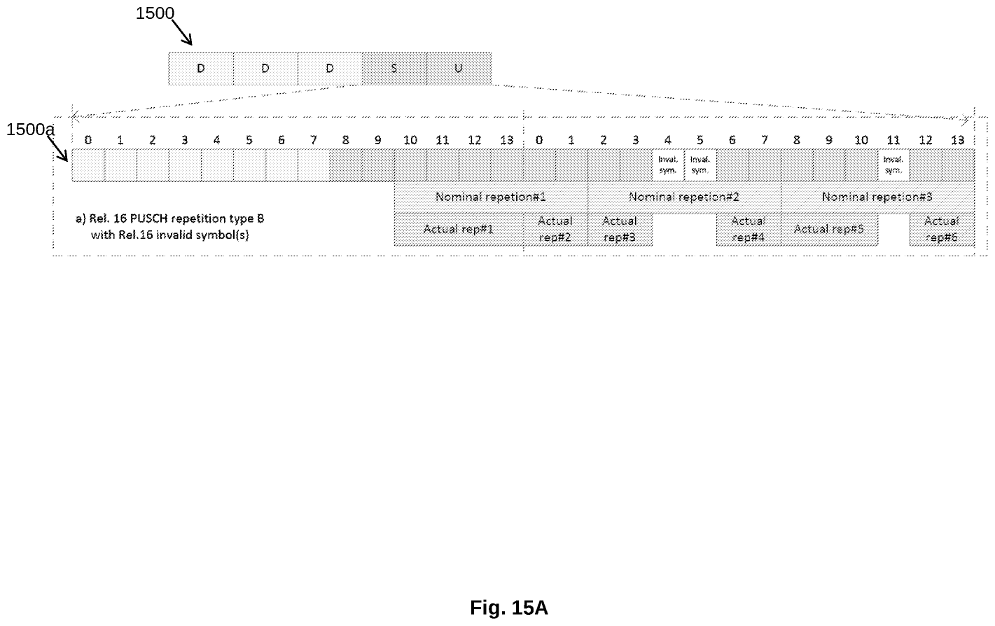

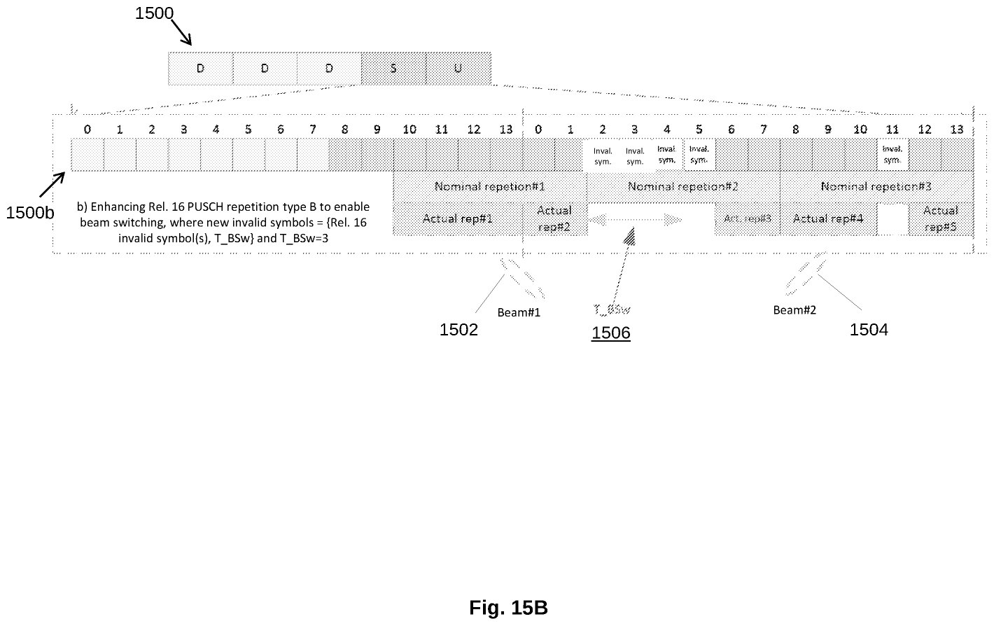

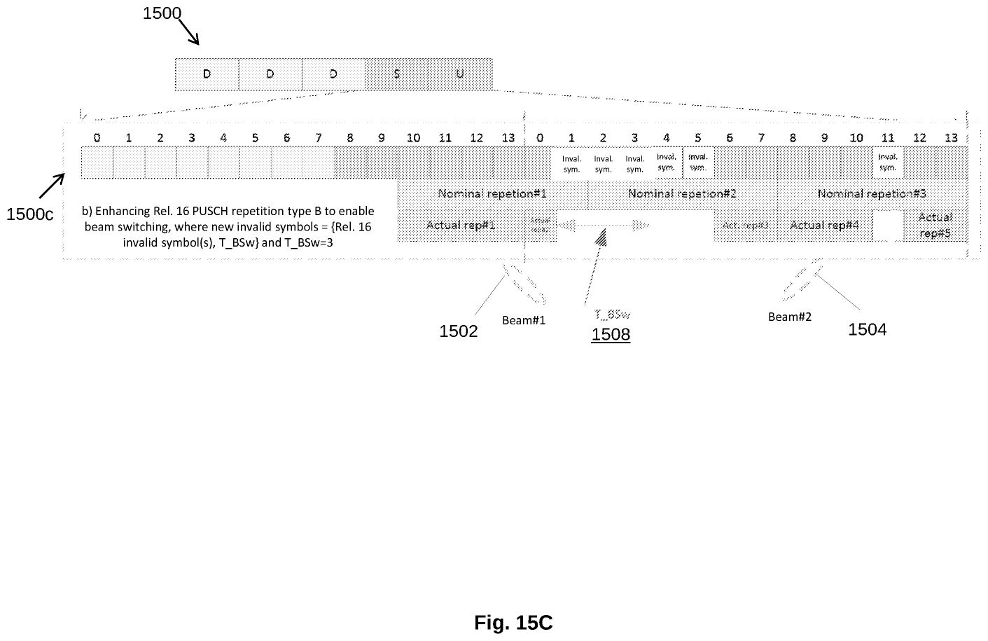

FIG. 15A shows a PUSCH repetition type B 1500a with Rel. 16 invalid symbols. In FIG. 15A, UE determines six actual repetitions #1-6 from three nominal repetition #1-3 based on Rel. 16 (legacy) invalid symbols, e.g. symbols #4-5 and symbol#11 in a UL slot.

In one case of this second example, determination of new invalid symbols and configuration of T_{BSw} for beam switching are independent of each other. On the other words, T_{BSw} is the time-domain resource allocation for a purpose of beam switching. In one case, new invalid symbols consisting of a Rel.16 invalid symbol(s) and T_{BSw} may be determined, in which the Rel.16 (legacy) invalid symbol(s) are non-overlapped with T_{BSw}, i.e., non-overlapped case. In this case, the beam switching is configured to be only applicable during the time duration specified by T_{BSw} 1508 as shown in FIG. 15C.

In another case of this second example, new invalid symbols as a union of a Rel.16 (legacy) invalid symbols and T_{BSw} may be determined, in which the Rel.16 invalid symbol(s) are overlapped with T_{BSw}, i.e., overlapped case. In addition, unlike the first example, determination of new invalid symbols in both non-overlapped and overlapped cases may not be applied for every occasion/event of a single one or more Rel.16 consecutive invalid symbols. In a manner of the overlapped case, a length of the union of a Rel.16 (legacy) invalid symbols and T_{BSw} is equal to or greater than the length of T_{BSw}.

Therefore, the beam switching is configured to be applicable either: only during the time duration specified by T_{Bsw} (e.g., in FIG. 158, in UL slot, the union symbols of of a Rel.16 (legacy) invalid symbols and T_{BSw} are symbols #2-5, where

TBSVI includes 3 symbols, beam switching is only configured during symbols #2-4 in the UL slot), (hereinafter referred to as Case i); or flexibly configured during the time duration of the union of a Rel.16 (legacy) invalid symbols and T_{BSw} (hereinafter referred to as Case ii).

In particular, FIG. 158 shows a PUSCH repetition type B 1500b with new invalid symbols according to another example of the second embodiment of the present disclosure. T_{BSw} 1506 is independently determined and includes 3 symbols such as symbols #2-4 in the UL slot, in which symbol #4 is overlapped with a symbol of Rel.16 (legacy) invalid symbol. New invalid symbols, which are the union symbols of of a Rel.16 (legacy) invalid symbols and T_{BSw}, are symbols #2-5 comprising the Rel.16 invalid symbol at symbols #4-5 in the UL slot. The UE further determines five actual repetitions #1-5 from the three nominal repetitions #1-3 based on the new invalid symbols as equation (4). For case beam switching is configured to apply during symbols #2-4 in the UL slot. For case ii, a possibility is that beam switching is configured during symbols #2-4 in UL slot, and another possibility is that beam switching is flexibly configured during symbols #3-5 in UL slot, i.e., flexibly configurable within the union of symbols. For instance, a first beam beam#1 1502 is used for a group of actual repetitions #1-2 and a second beam beam#2 1504 is used for a group of actual repetitions #3-5, In another embodiment, the independently configured T_{BSw} may not overlapped with Rel.16 invalid symbol as shown in FIG. 15C, In FIG. 15C, T_{BSw} 1508 is independently determined and includes 3 symbols such as symbols #1-3 in the UL slot, while they do not overlap with a symbol of Rel. 16 (legacy) invalid symbol at symbols #4-5, Beam switching is configured to apply during symbol #1-3 in UL slot. It should be appreciated that the time-allocation resource allocation/assignment for actual repetitions of the non-overlapped case are different from that of the overlapped case; within the overlapped case, the time-allocation resource allocation/assignment for actual repetitions are the same for the both cases i and

In the following paragraphs, certain examples relating to a third

embodiment of the present disclosure are explained with reference to a UE for uplink transmission with symbol level repetition multiple beams.

Symbol level repetition includes concepts of virtual symbol and virtual slot. A virtual symbol contains a number of consecutive symbols corresponding to virtualsymbolLength; whereas a virtual slot consists of a number of consecutive virtual symbols. This is by assuming a joint combination of symbol level repetition and slot level repetition (repetition type A specified in Rel. 15, where different repetition is transmitted in different (virtual) slot with same length and starting symbol) is used, i.e. virtual slot level repetition. In particular, virtual symbols (repetition) are repeated over multiple virtual slots. As such, Rel. 15 repetition procedure can be reused by replacing the symbol/slot with virtual symbol/slot.

Beam switching among multiple beams is applied if an interval (e.g. duration time) between two consecutive repetitions of virtual symbols is not less than T_{BSw}. This may refer to as inter-virtual slot level beam switching/mapping. Such beam switching in this embodiment is similar to the first embodiments, but with symbol level repetition (virtual symbol and virtual slot). Hence, it is appreciable that all variations of the first embodiments of the present disclosure may be used in this third embodiment and its variation by replacing virtual symbol/slot with symbol/slot, and descriptions thereof in regard to different variations of this embodiment are omitted. For example, one of the beam mapping patterns such as cyclical beam mapping pattern, sequential beam mapping pattern, half-half beam mapping pattern and configurable beam mapping pattern may be used to perform beam mapping for repetitions of virtual symbols over multiple virtual slots.

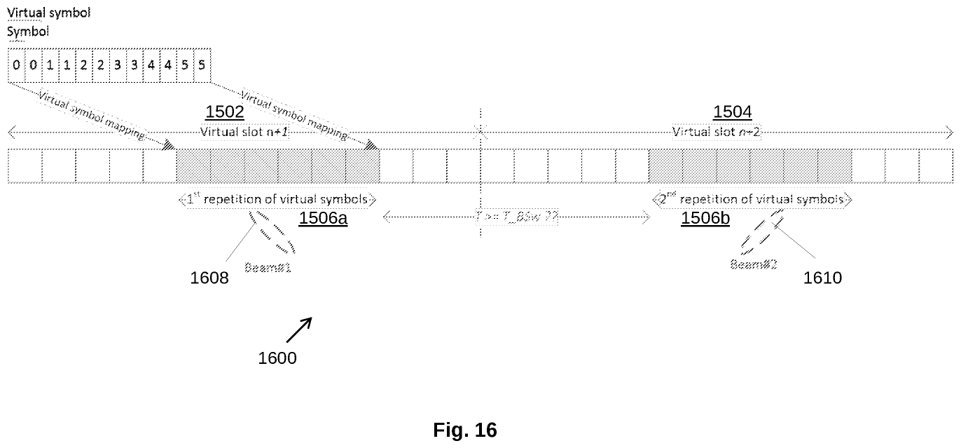

FIG. 16 shows an example symbol level repetition according to the third embodiment of the present disclosure. Six virtual symbols 1506a are mapped in virtual slot n+1 1502, each of the virtual symbols 1506a including 2 consecutive symbols (virtualsymbolLength=2). A repetition 1506b of these virtual symbols is mapped in virtual slot n+2 1504. If two consecutive repetitions of the virtual symbols 1506a, 1506b have an interval T (e.g. a duration time) not less than T_{BSw}, beam switching among multiple beams is enabled. If so, beam#1 1608 and beam#2 1610 are used for the first repetition 1506a and the second repetition 1506b of the virtual symbols respectively.

To perform the operation of the third embodiment, a UE is provided with a number of symbols per virtual symbol (virtualsymbolength), number of virtual symbols per virtual slot and/or number of repetitions of the virtual slot by using at least one of a DCI signalling, a MAC CE signalling, or a RRC signalling, as well as information of beam mapping and switching.

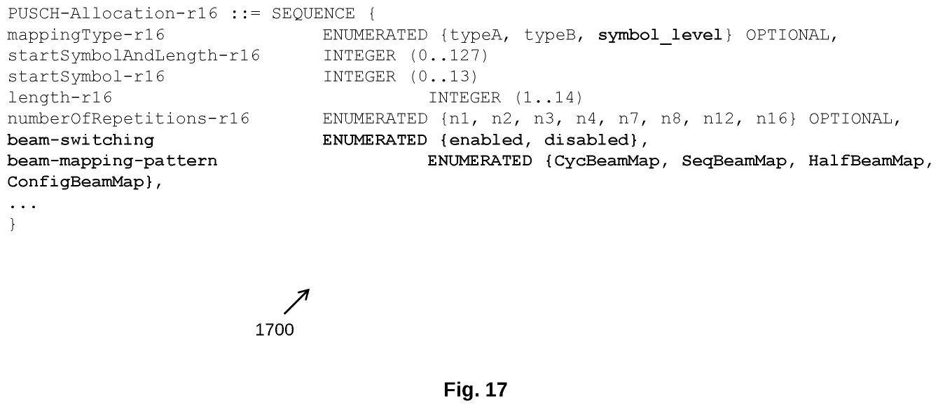

FIG. 17 shows an example PUSCH allocation configuration for beam switching for a plurality of uplink transmission occasions according to the third embodiment of the present disclosure. PUSCH-Allocation-r16 is enhanced to indicate symbol level repetition by adding new entry symbol indicate time-domain resource assignment (TDRA) of virtual symbols for PUSCH allocation and beam-switching, similar to the first embodiment. When symbol level is configured and numberOfRepetitions-r16<1, the UE may be further configured to enable one of beam mapping patterns in beam-mapping-pattern.

In a variation of the third embodiment of the present disclosure, a frequency hopping procedure is used based on at least virtual symbols/slot. Demodulation reference signal for frequency hopping can be enabled based on the virtual symbols/slot. In particular, each of the repetitions of virtual symbols may correspond to a frequency hop. As such, beam switching among multiple beams is applied if an interval (e.g. duration time) between two consecutive frequency hops is not less than T_{BSw}. All variations of the first embodiments may still be applied to this variation of the third embodiment of the present disclosure. For example, one of the beam mapping patterns such as cyclical beam mapping pattern, sequential beam mapping pattern, half-half beam mapping pattern and configurable beam mapping pattern may be used to perform beam mapping for frequency hops. To perform such operation, Rel. 15/16 inter-slot frequency hopping procedure can be reused by replacing the inter-slot with inter-virtual slot. Advantageously, this variation can help to achieve frequency hopping gain.

While the above example describes symbol level repetition (with inter-virtual slot level beam switching/mapping) using concept of repetition type A, in another consideration of the third embodiment, a joint combination of symbol level repetition and concept of repetition type B may be used. In such variation, beam switching among multiple beams may be applied in a way similar to that in the second embodiments, where new invalid symbols may be introduced with symbol level repetition (virtual symbols) over virtual slots.

In the following paragraphs, certain examples relating to a fourth embodiment of the present disclosure are explained with reference to a UE for uplink transmission with transport block (TB) processing over multiple slots multiple beams.

For TB processing over multiple slots, a TB size is obtained for a single slot, but is mapped and transmitted in multiple parts over multiple slots. Beam switching among multiple beams is applied if an interval (e.g., duration time) between two consecutive mapped parts (over two consecutive or non-consecutive slots) is not less than T_{BSw}. All variations of the first embodiments of the present disclosure may be used in this fourth embodiment and its variations by replacing the mapped parts with the repetitions or uplink transmission occasions. Advantageously, this can achieve coding and time diversity gains.

In a first variation of the fourth embodiment, a joint repletion and TB processing over multiple slots is applied. A TB size is obtained for a single slot (or virtual slot) or multiple slots (or multiple virtual slots). The TB (over a single slot of multiple slots) is repeated to transmit multiple times in a time-domain, each repetition corresponding to a transmission occasion of the TB. Beam switching among multiple beams is applied if an interval (e.g., duration time) between two consecutive repetitions of the TB is not less than T_{BSw}.

In a second variation of the fourth embodiment, a frequency hopping procedure is applied to each of multiple parts (over multiple slots). Beam switching among multiple beams is applied is applied if an interval between an interval (e.g., duration time) between two consecutive frequency hops is not less than T_{BSw}.

In a third variation of the fourth embodiment, TB can be mapped and transmitted in parts over multiple virtual slots.

In the following paragraphs, certain exemplary embodiments of the present disclosure are explained with reference to a UE for other considerations for enhancing uplink transmission with multiple beams.

In various embodiments, the required latency of beam switching T_{BSw} is expressed in a symbol unit. In an embodiment, when T_{BSw} is very small or negligible, at least intra-slot (or intra-virtual slot) level beam switching can be applied. In this embodiment, each beam of multiple beams is used for one of nominal/actual repetitions.

For instance, for low subcarrier spacings (SCSs), e.g., SCSs of 15 kHz, 30 kHz, etc, the required latency of beam switching T_{BSw} is not greater than a duration of cyclic prefix of a OFDM symbol, the UE can switch among beams within this cyclic prefix. It is sufficient to apply both intra-slot (or intra-virtual slot) level beam switching and inter-slot (or inter-virtual slot) level beam switching. Another instance is that the UE can switch among beams within a guard duration between 2 consecutive slots for inter-slot (or inter-virtual slot) level beam switching, if this guard duration is not less than the required latency of beam switching. For high SCSs for NR operation in millimeter wave (mmWave), e.g., SCSs of 480 kHz and 960 kHz for NR operation from 52.6 GHz to 71 GHz or higher than 71 GHz, due to a shorter duration time of a OFDM symbol, the required latency of beam switching is equal to or greater than the duration time of a OFDM symbol. In this manner, it is more sufficient to apply inter-slot (or inter-virtual slot) level beam switching than the intra-slot (or intra-virtual slot) level beam switching. It is appreciated to note that if the required latency of beam switching is satisfied, the intra-slot (or intra-virtual slot) level beam switching is applicable in this manner as well.

Also in an embodiment, each of the multiple beams for beam switching are configured with a set of power control parameters.

For codebook-based transmission, to enable PUSCH repetitions with multiple beams, in one embodiment, multiple PUSCH transmit precoders from the codebook are indicated by using multiple indications such as current transmit precoding matrix indication (TPMI) and a new sounding reference signal resource indicator (SRI) in a DCI signalling. Each of the multiple beams is associated with one of TPMIs from the codebook for codebook-based transmission based on control information received from gNB. Each of the multiple beams may be associated with one of SRS resource sets, which in turn associated with a channel state information reference signal (CSI-RS) resource, for codebook-based transmission. The one of SRS resource sets may be indicted using the new SRI in the DCI signalling. In one other embodiment, current TPMI or SRI in a DCI signalling may be reinterpreted to indicate multiple PUSCH transmit precoders or SRS resource sets respectively to enable PUSCH repetitions with multiple beams.

For non-codebook-based transmission, to enable PUSCH repetitions with multiple beams, in one embodiment, for each TRP, one sounding reference signal (SRS) resource set associates with multiple non-zero-power channel state information reference signals (NZP SCI-RSs). The SRS resource set is configured by a higher layer parameter such as srs-ResourceSetToAddModList and associated with the higher layer parameter usage of value ‘nonCodeBook’. In one other embodiment, for each TRP, multiple SRS resource set may be configured, where each of SRS resource set is associated with one NZP CSI-RS and associated with the higher layer parameter usage of value ‘nonCodeBook’.

In an embodiment, multiple transmission configuration indicator (TCI) states can be indicated in a DCI signalling and replace multiple beams to be used for PUSCH transmission occasions of the above-mentioned first to fourth embodiments of the present disclosure for switching of multiple spatial information,

If a unified TCI state is indicated for both UL and DL, the unified TCI state is used for both DL and UL repetitions.

In an embodiment, the above-mentioned first to fourth embodiments of the present disclosure can be applied for a PUCCH repetition framework. They may also be used for PUCCH/PUSCH repetitions in non-consecutive slots. They may also be directly applied to support more than two beams and/or more than two TRPs.

Yet in another embodiment, multiple embodiments described above may be applied simultaneously at a single UE for enhancing uplink transmission with multiple beams.

The present disclosure provides the following examples:

1. A communication apparatus comprising:
a transceiver, which in operation, receives control information indicating two or more beams for uplink transmissions; and
circuitry, which in operation, uses the two or more beams for a plurality of uplink transmission occasions in response to meeting at least one condition for beam switching based on the control information.

2. The communication apparatus of example 1, wherein each of the plurality of uplink transmission occasions is a physical uplink control channel (PUCCH), physical uplink shared channel (PUSCH) processing from one or more transport blocks, a sounding reference signal (SRS), or physical random access (PRACH) transmission occasion, and is defined by a slot index, a starting symbol, and a number of consecutive symbols.

3. The communication apparatus of example 1, wherein each of the plurality of uplink transmission occasions is a transmission occasion among a plurality of repetitions of a PUCCH or PUSCH in an inter-slot level repetition framework, or a transmission occasion among a plurality of nominallactual repetitions of the PUCCH or PUSCH in an intra-slot level repetition framework.

4. The communication apparatus of example 1, wherein the at least one condition is receiving an explicit indication of performing beam switching in a time-domain from a base communication apparatus based on the control information.

5. The communication apparatus of example 1, wherein the transceiver receives the control information by using at least one of a downlink control information (DCI) signaling, a medium access control layer control element (MAC CE) signaling, or a radio resource control (RRC) signaling.

6. The communication apparatus of example 1, wherein the at least one condition is that a first interval between two consecutive uplink transmission occasions of the plurality of uplink transmission occasions is not less than required latency of beam switching.

7. The communication apparatus of example 1, wherein the circuity is further configured to provide an assistance information to a base communication apparatus, the assistance information relating to a configuration of the two or more beams for the plurality of uplink transmission occasions.

8. The communication apparatus of example 7, wherein the assistance information includes at least preferences of a required latency of beam switching, processing timeline parameters, antenna configurations, bandwidth parts, CSI measurements, and/or spatial information, based on capabilities of the communication apparatus.

9. The communication apparatus of example 6, wherein the circuitry is further configured to determine the first interval between the two consecutive uplink transmission occasions based on a length of each of the two consecutive uplink transmission occasions.

10. The communication apparatus of example 1, wherein the circuitry is configured to use each of the two or more beams for the plurality of uplink transmission occasions in a cyclical or a sequential pattern in response to meeting the at least one condition.

11. The communication apparatus of example 1, wherein the circuitry is configured to use a first half of the two or more beams for a first half of the plurality of uplink transmission occasions, and a second half of the two or more beams for a second half of the plurality of uplink transmission occasions in response to meeting the at least one condition.

12. The communication apparatus of example 1, wherein the circuity is configured to use one of the two or more beams for the plurality of uplink transmission occasions in response to not meeting the at least one condition.

13. The communication apparatus of any one of examples 1-3, wherein the circuity is further configured to use a first beam of the two or more beams for one or more uplink transmission occasions of the plurality of uplink transmission occasion and remove the remaining uplink transmission occasions of the plurality of uplink transmission occasions in response to not meeting the at least condition, wherein the first beam is the strongest beam among the two or more beams.

14. The communication apparatus of example 13, wherein, when the at least one condition is not met, the circuitry is configured to postpone or shift the remaining uplink transmission occasions.

15. The communication apparatus of example 1, wherein a usage of each of the two or more beams for the plurality of uplink transmission occasions is configurable.

16. The communication apparatus of any one of examples 1-3, wherein the circuitry is further configured to:
determine new invalid symbols based on a single one or more consecutive legacy invalid symbols and a required latency of beam switching, wherein the new invalid symbols have a length corresponding to a greater one of a length of the required latency of beam switching and a length of the single one or more consecutive legacy invalid symbols; and
determine the plurality of uplink transmission occasions based on the new invalid symbols; and
use the two or more beams for the plurality of uplink transmission occasions in response to the determinations.

17. The communication apparatus of example 16, wherein the determination of the plurality of uplink transmission occasions based on the new invalid symbols is applied to every single one or more consecutive legacy invalid symbols.

18. The communication apparatus of any one of examples 1-3, wherein the circuitry is further configured to:
determine new invalid symbols consisting of a single one or more consecutive legacy invalid symbols and a required latency of beam switching, wherein the single one or more consecutive legacy invalid symbols are non-overlapped with the required latency of beam switching;
determine the plurality of uplink transmission occasions based on the new invalid symbols; and
use the two or more beams for the plurality of uplink transmission occasions in response to the determinations.

19. The communication apparatus of any one of examples 1-3, wherein the circuitry is further configured to:
determine new invalid symbols as a union of a single one or more consecutive legacy invalid symbols and a required latency of beam switching; and
determine the plurality of uplink transmission occasions based on the new invalid symbols; and
use the two or more beams for the plurality of uplink transmission occasions in response to the determinations.

20. The communication apparatus of example 19, wherein the circuitry is flexibly configured to perform beam switching within the union of the single one or more consecutive legacy invalid symbols and the required latency of beam switching

21. The communication apparatus of example 1, wherein the circuitry is configured to use each of the two or more beams for a subset of the plurality of uplink transmission occasions when the at least one condition is met.

22. The communication apparatus of any one of examples 16-20, wherein the required latency of beam switching is configured as periodic or aperiodic by the control information.

23. The communication apparatus of example 1, wherein each of the plurality of uplink transmission occasions correspond to one of a plurality of parts processing from one or more transport blocks; wherein each of the plurality of parts processing from the one or more transport blocks is mapped to one of a corresponding plurality of slots.

24. The communication apparatus of example 1 , wherein the one or more transport blocks are further configured by the control information to repeat multiple times in a time-domain, wherein each of the plurality of uplink transmission occasions correspond a transmission occasion of the one or more transport blocks, wherein the at least one condition is that a second interval between two consecutive repetitions of the one or more transport blocks is not less than a required latency of beam switching.

25. The communication apparatus of any one of examples 1-3, wherein each of the plurality of uplink transmission occasions corresponds to one of a plurality of repetitions of virtual symbols over multiple virtual slots, wherein a virtual symbol includes a number of consecutive symbols, and a virtual slot includes a number of consecutive virtual symbols in symbol level repetition.

26. The communication apparatus of example 1, wherein each of the plurality of uplink transmission occasions corresponds to one of a plurality frequency hops, wherein the at least one condition is that a third interval between two consecutive frequency hops is not less than a required latency of beam switching.

27. The communication apparatus of example 1, wherein each of the two or more beams are configured with a set of power control parameters.

28. The communication apparatus of example 1, wherein the circuitry is further configured to associate each of the two or more beams with at least one of a plurality of transmit precoders from the codebook for codebook-based transmission based on the control information.

29. The communication apparatus of example 28, wherein the one of a plurality of transmit precoders is indicated by using at least a transmit preceding matrix indication (TPMI) and/or a sounding reference signal resource indicator (SRI) in a DCI signalling.

30. The communication apparatus of example 28, wherein the plurality of transmit precoders are indicated by reinterpreting at least a INA and/or an SRI in a DCI signalling.

31. The communication apparatus of example 1, wherein the circuitry is configured to associate each of the two or more beams with at least one of sounding reference signal (SRS) resource sets for codebook-based transmission, wherein the at least one of SRS resource sets is associated with a channel state information reference signal (CSI-RS) resource.

32. The communication apparatus of example 31, wherein the one of SRS resource sets is indicated by using at least an SRI in a DCI signalling.

33. The communication apparatus of example 31, wherein the SRS resource sets are indicated by reinterpreting at least an SRI in a DCI signalling.

34. The communication apparatus of example 1, wherein the circuitry is configured to associate each of the two or more beams with one of a plurality of transmission configuration indicator (TCI) states.

35. The communication apparatus of any one of examples 6, 8, 16-20, 22, 24 and 26, wherein the required latency of beam switching is expressed in a symbol unit.

36. The communication apparatus of example 35, wherein the circuity is configured to apply intra-slot or intra-virtual-slot level beam switching when the required latency of beam switching is very small or negligible, wherein one of the two or more beams is used for one of the plurality of uplink transmission occasions.

37. The communication apparatus of any one of examples 1 to 36, wherein the circuity is configured to use the two or more beams for the plurality of uplink transmission occasions for either single or multiple transmission and reception points (TRPs); wherein each of the two or more beams corresponds to one of the multiple TRPs.

38. A base communication apparatus, comprising:
circuitry, which in operation, generates control information indicating an explicit indication and/or a required latency of beam switching for two or more beams for uplink transmissions; and
a transmitter, which in operation, transmits the control information to a communication apparatus.

39. A communication method, comprising:
receiving control information indicating two or more beams for uplink transmissions; and
using the two or more beams for a plurality of uplink transmission occasions in response to meeting at least one condition for beam switching based on the control information.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

TABLE 1
Applicable PUSCH time domain resource allocation for common
search space and DCI format 0_0 in UE specific search space

| | PDCCH | pusch-ConfigCommon | Push-Config | PUSCH time domain |
|---|---|---|---|---|
| | search | includes pusch- | includes pusch- | resource allocation |
| RNTI | space | TimeDomainAllocationList | TimeDomainAllocationList | to apply |
| PUSCH scheduled by | | No | — | Default A |
| MAC RAR as described | | Yes | | Push- |
| in clause 8.2 of [6, TS | | | | TimeDomainAllocationList |
| 38.213] or MAC fallback | | | | provided in pusch- |
| RAR as described in | | | | Config Common |
| clause 8.2A of [6. 38.213] | | | | |
| or for MsgA PUSCH | | | | |
| transmission | | | | |
| C-RNTI, | Any common | No | — | Default A |
| MCS-C- | search space | Yes | | pusch- |
| RNTI, | associated | | | TimeDomainAllocationList |
| TC-RNTI, | with | | | provided in pusch- |
| CS-RNTI | CORESET 0 | | | ConfigCommon |
| C-RNTI, | Any common | No | No | Default A |
| MCS-C- | space not | Yes | No | pusch- |
| RNTI, | associated | | | TimeDomainAllocationList |
| TC-RNTI, | with | | | provided in pusch- |
| CS-RNTI, | CORESET 0, | | | ConfigCommon |
| SP-CSI- | DCI format | No/Yes | Yes | pusch- |
| RNTI | 0_0 in UE | | | TimeDomainAllocationList |
| | specific | | | provided in pusch-Config |
| | search space | | | |

TABLE 2
Default PUSCH time domain resource allocation A for normal CP

| Row | PUSCH | | | |
|---|---|---|---|---|
| index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

1-20. (canceled)

21. A communication apparatus, comprising:
a transceiver, which, in operation, receives control information indicating two or more beams for uplink transmissions; and
circuitry, which, in operation, uses the two or more beams for a plurality of uplink transmission occasions based on the control information and based on at least one condition for beam switching.

22. The communication apparatus of claim 21, wherein the plurality of uplink transmission occasions include one or more of a physical uplink control channel (PUCCH) transmission occasion, a physical uplink shared channel (PUSCH) processing from one or more transport blocks, a sounding reference signal (SRS) transmission occasion, or a physical random access (PRACH) transmission occasion, and are defined by a slot index, a starting symbol, and a number of consecutive symbols.

23. The communication apparatus of claim 21, wherein the plurality of uplink transmission occasions are transmission occasions among a plurality of repetitions of a physical uplink control channel (PUCCH) or a physical uplink shared channel (PUSCH) in an inter-slot level repetition framework, or transmission occasions among a plurality of nominal actual repetitions of the PUCCH or the PUSCH in an intra-slot level repetition framework.

24. The communication apparatus of claim 21, wherein the transceiver, in operation, receives an explicit indication of performing the beam switching in a time domain from a base communication apparatus, wherein the at least one condition for beam switching is based on the explicit indication.

25. The communication apparatus of claim 21, wherein the transceiver, in operation, receives the control information by using at least one of a downlink control information (DCI) signaling, a medium access control layer control element (MAC CE) signaling, or a radio resource control (RRC) signaling.

26. The communication apparatus of claim 21, wherein the at least one condition is that a first interval between two consecutive uplink transmission occasions of the plurality of uplink transmission occasions is not less than a required latency of beam switching.

27. The communication apparatus of claim 26, wherein the beam switching is performed within a cyclic prefix in case the required latency of beam switching is not greater than a duration of the cyclic prefix.

28. The communication apparatus of claim 21, wherein the circuity, in operation, provides assistance information to a base communication apparatus based on capabilities of the two or more beams.

29. The communication apparatus of claim 21, wherein the circuitry, in operation, uses the two or more beams for the plurality of uplink transmission occasions in a cyclical or a sequential pattern.

30. The communication apparatus of claim 21, wherein the circuitry, in operation, associates the two or more beams with a plurality of transmission configuration indicator (TCI) states.

31. The communication apparatus of claim 21, wherein the two or more beams are configured with a set of power control parameters.

32. The communication apparatus of claim 21, wherein the circuitry, in operation, associates the two or more beams with at least one of a plurality of transmit precoders from a codebook for codebook-based transmission based on the control information.

33. The communication apparatus of claim 32, wherein the one of a plurality of transmit precoders is indicated by using at least a transmit preceding matrix indicator (TPMI) and/or a sounding reference signal resource indicator (SRI) in a downlink control information (DCI) signalling.

34. The communication apparatus of claim 21, wherein the circuitry, in operation, associates the two or more beams with at least one of sounding reference signal (SRS) resource sets for codebook-based transmission, wherein the at least one of SRS resource sets is associated with a channel state information reference signal (CSI-RS) resource.

35. The communication apparatus of claim 34. wherein the at least one of SRS resource sets is indicated by using at least a signal resource indicator (SRI) in a downlink control information (DCI) signalling.

36. A communication method, comprising:
receiving control information indicating two or more beams for uplink transmissions; and
using the two or more beams for a plurality of uplink transmission occasions based on the control information and based on at least one condition for beam switching.
